(19) United States
(12) Patent Application Publication
(10) Pub. No.: US 2023/0283376 A1
(43) Pub. Date: Sep. 7, 2023

(54) FIBER OPTIC COMMUNICATION SYSTEM FOR VEHICLES

(71) Applicant: EQUINOX INNOVATIVE SYSTEMS, COLUMBIA, MD (US)

(72) Inventors: RANDAL MORSER, COLUMBIA, MD (US); CORDELL REID, BALTIMORE, MD (US); JUSTIN OWENS, BALTIMORE, MD (US); ADRIAN RIVERA-BALASQUIDE, COLUMBIA, MD (US)

(73) Assignee: EQUINOX INNOVATIVE SYSTEMS, COLUMBIA, MD (US)

(21) Appl. No.: 18/141,622

(22) Filed: May 1, 2023

Related U.S. Application Data
(60) Provisional application No. 63/315,250, filed on Mar. 1, 2022.

(51) Int. Cl. H04B 10/2575; H04B 10/118

(52) U.S. Cl. CPC H04B 10/25759; H04B 10/118

(57) ABSTRACT

The fiber optic communication system for vehicles is a system for extending communication capabilities for vehicles, such as ships and other watercraft, for example, through connection to an external wireless communication module using a fiber optic cable. The fiber optic communication system for vehicles includes a first fiber optic converter adapted to be carried by the vehicle and further adapted for electrical connection to at least one user device. The fiber optic communication system for vehicles further includes a second fiber optic converter adapted to be positioned remotely from the vehicle and the first fiber optic converter. At least one fiber optic cable optically couples the first fiber optic converter and the second fiber optic converter, and a wireless communication module is in electrical communication with the second fiber optic converter.

### CROSS-REFERENCE TO RELATED APPLICATIONS

This application claims the benefit of U.S. Provisional Patent Application No. 63/315,250, filed on Mar. 1, 2022.

### BACKGROUND OF THE INVENTION

### Field of the Invention

The disclosure of the present patent application relates to communication to and from vehicles, such as ships and other watercraft, for example, and particularly to a vehicular communication system connected to an external wireless communication module through a fiber optic cable.

### Description of Related Art

Maritime wireless communication systems are used for numerous applications where network nodes on a watercraft require connectivity to components and systems which are external to the watercraft, such as connections using Internet protocol (IP), serial connections, and streaming video components, for example, both onboard and away from the watercraft. Conventional maritime wireless communication systems are limited to the confines of the watercraft, resulting in a loss of signal intensity, poor signal quality, degradation of network speeds, and periods of time where no wireless signal is available. This poor connectivity between components can severely degrade the performance of the communication system as a whole and can pose a great risk for those traveling on the vessel. There is a need to extend the capabilities of presently available onboard communication systems without requiring upgrades to higher power systems. Thus, a fiber optic communication system for vehicles solving the aforementioned problems is desired.

### SUMMARY OF THE INVENTION

The fiber optic communication system for vehicles is a system for extending communication capabilities for vehicles, such as ships and other watercraft, for example, through connection to an external wireless communication module using a fiber optic cable. The fiber optic communication system for vehicles includes a first fiber optic converter adapted to be carried by the vehicle and further adapted for electrical connection to at least one user device. The fiber optic communication system for vehicles further includes a second fiber optic converter adapted to be positioned remotely from the vehicle and the first fiber optic converter. At least one fiber optic cable optically couples the first fiber optic converter and the second fiber optic converter, and a wireless communication module is in electrical communication with the second fiber optic converter.

The first fiber optic converter is configured to convert first electrical signals received from the at least one user device into first optical signals, and is further configured to convert second optical signals into second electrical signals received by the at least one user device. The second fiber optic converter is configured to convert the first optical signals from the first fiber optic converter into third electrical signals received by the wireless communication module, and is further configured to convert fourth electrical signals received from the wireless communication module into the second optical signals received by the first fiber optic converter.

The wireless communication module may be electrically connected to the second fiber optic converter through a connector hub. Additionally, the second fiber optic converter and the connector hub may be housed together within a first enclosure, which may be a waterproof enclosure for floating on, or submersion in, a body of water. The wireless communication module may be located external to the first enclosure, and may be housed within a second enclosure, also external to the first enclosure. The wireless communication module may include a wireless transceiver in electrical communication with a wireless antenna through a radio frequency (RF) amplifier.

These and other features of the present subject matter will become readily apparent upon further review of the following specification.

### BRIEF DESCRIPTION OF DRAWINGS

FIG. 1 diagrammatically illustrates a fiber optic communication system for vehicles.

FIG. 2 is a block diagram illustrating system components of a remote station of the fiber optic communication system for vehicles.

Similar reference characters denote corresponding features consistently throughout the attached drawings.

### DETAILED DESCRIPTION

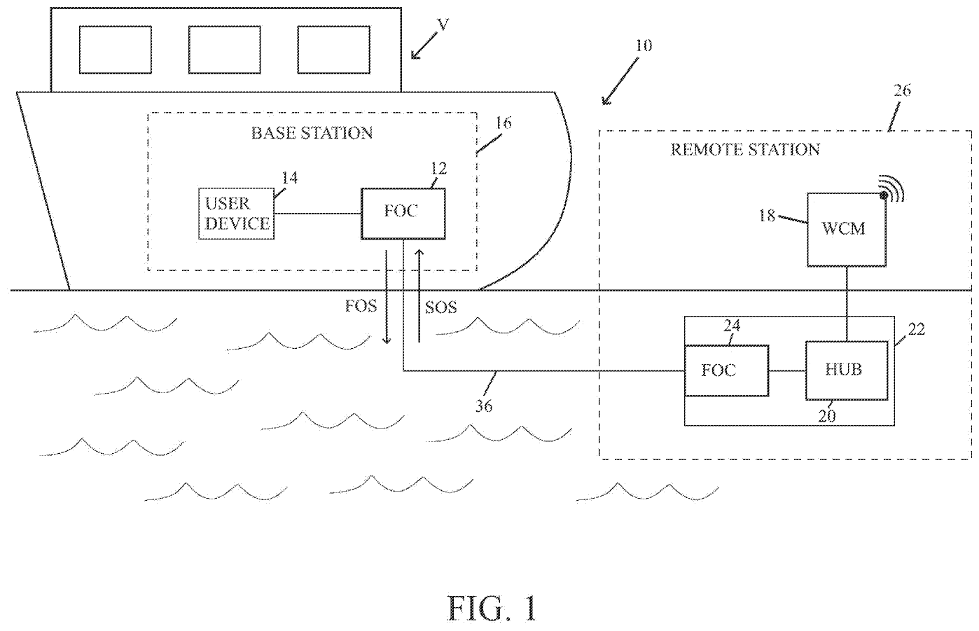

The fiber optic communication system for vehicles 10 is a system for extending communication capabilities for vehicles, such as ships and other watercraft, for example, through connection to an external wireless communication module (WCM) 18 using a fiber optic cable 36. It should be understood that the fiber optic communication system for vehicles 10 may be used with any suitable type of vehicle, and that the water faring vessel V shown in FIG. 1 is shown for exemplary purposes only.

The fiber optic communication system for vehicles 10 includes a first fiber optic converter (FOC) 12 adapted to be carried by the vehicle V and which is further adapted for electrical connection to at least one user device 14. It should be understood that the at least one user device 14 may be any conventional device capable of communication and which may be carried on the vehicle V, such as, but not limited to, a personal computer, a laptop computer, a tablet computer, a smartphone, or the like. As shown in FIG. 1, the first fiber optic converter 12 and the at least one user device 14 may be integrated into, or constitute at least part of, a base station 16 carried on vehicle V.

The fiber optic communication system for vehicles 10 further includes a second fiber optic converter (FOC) 24 adapted to be positioned remotely from the vehicle V and the first fiber optic converter 12. At least one fiber optic cable 36 optically couples the first fiber optic converter 12 and the second fiber optic converter 24, and a wireless communication module (WCM) 18 is in electrical communication with the second fiber optic converter 24.

The first fiber optic converter 12 is configured to convert first electrical signals received from the at least one user device 14 into first optical signals (FOS), and is further configured to convert second optical signals (SOS) into second electrical signals received by the at least one user device 14. The second fiber optic converter 24 is configured to convert the first optical signals (FOS) received from the first fiber optic converter 12 into third electrical signals received by the wireless communication module 18, and is further configured to convert fourth electrical signals received from the wireless communication module 18 into the second optical signals (SOS) received by the first fiber optic converter 12 through the at least one fiber optic cable 36.

It should be understood that the first and second fiber optic converters 12, 24 may be any suitable type of converters for converting electrical signals into optical signals and vice versa, as is well known in the art. Such converters are commonly referred to in the art as “media converters”. Further, it should be understood that the at least one fiber optic cable 36 may be any suitable type of fiber optic cable, such as, but not limited to, a cable containing one or more single mode or multimode optical fibers.

The wireless communication module 18 may be electrically connected to the second fiber optic converter 24 through a connector hub 20. Connector hub 20 may include any suitable type of connectors or couplers. As a non-limiting example, connector hub 20 may be a universal serial bus (USB) hub containing multiple USB ports.

Additionally, the second fiber optic converter 24 and the connector hub 20 may be housed together within a first enclosure 22, which may be a waterproof enclosure for floating on, or submersion in, a body of water, as a non-limiting example. It should be understood that the second fiber optic converter 24 and the connector hub 20 may be mounted and secured within the first enclosure 22 using any suitable type of attachments, such as, for example, mounting brackets, fasteners and the like.

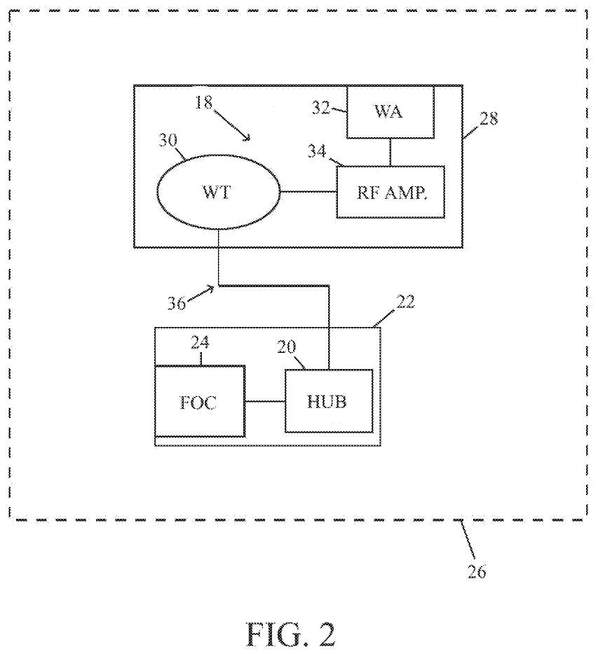

The wireless communication module 18 may be located external to the first enclosure 22 and, as shown in FIG. 2, may be housed within a second enclosure 28, also external to the first enclosure 22. As shown in FIG. 1, the wireless communication module, the first fiber optic converter 24 and the connector hub 20 may together define a remote station 26 for performing wireless communication at a location which is remote from the vehicle V. It should be understood that the wireless communication module 18 may be mounted and secured within the second enclosure 28 using any suitable type of attachments, such as, for example, mounting brackets, fasteners or the like. The second enclosure 28 may also be a waterproof enclosure. Alternatively, the wireless communication module 18 may be mounted within the first enclosure 22 with the second fiber optic converter 24 and the connector hub 20.

It should be understood that the wireless communication module 18 may be any suitable type of wireless communication system, as is well known in the art. In the non-limiting example of FIG. 2, the wireless communication module 18 includes a wireless transceiver (WT) 30 in electrical communication with a wireless antenna (WA) 32 through a radio frequency (RF) amplifier 34, as is well known in the art. It should be understood that wireless transceiver 30 may be any suitable type of wireless transceiver, including, but not limited to, a broad spectrum RF transceiver for transmitting and receiving signals over, for example, the 20 MHz to 100 GHz range. As another non-limiting example, the wireless transceiver 30 may be a Wi-Fi transceiver operating in the 2.4 GHz to 5.8 GHz range. It should be similarly understood that wireless antenna 32 may be any suitable type of wireless antenna for transmitting and receiving wireless signals in conjunction with wireless transceiver 30, such as a directional panel antenna or the like. The wireless antenna 32 may be integrated into a single unit also containing wireless transceiver 30 or, alternatively, the wireless antenna 32 may be positioned external to wireless transceiver 30 and/or second enclosure 28. As a non-limiting example, the second enclosure 28 may be equipped with a telescopic mast or other type of extending support structure for supporting the wireless antenna 32 in a raised position and/or in a desired orientation.

It should be understood that the at least one fiber optic cable 36 may have any necessary length for carrying optical signals between the base station 16 and the remote station 26. It should be further understood that the length of the at least one fiber optic cable 36 may be adjustable. For example, the vehicle V and/or the remote station 26 may carry a spool or the like for automatically or manually winding and unwinding the at least one fiber optic cable 36. It should be further understood that the at least one fiber optic cable 36 may be coupled to the first and second fiber optic converters 12, 24 using any suitable type of optical couplers, optical connectors or the like. Further, it should be understood that the at least one user device 14 may be electrically connected to the first fiber optic converter 12 using any suitable type of connector(s), such as, for example, a conventional USB connection. Similarly, it should be understood that the connector hub 20 may be electrically connected to the second fiber optic converter 24 using any suitable type of connector(s), such as, for example, a conventional USB connection.

In use, as a non-limiting example, a human diver may be used to position the remote station 26 external to the vehicle V. As a further non-limiting example, the first enclosure 22 may be attached to, or carried by, the diver using straps or the like. The diver may carry the remote station 26 on the surface of the water or underwater to extend the wireless communication capabilities of the at least one user device 14 on the vehicle V. In another non-limiting example, a remotely operated vehicle (ROV) or autonomous underwater vehicle (AUV) may be used to position the remote station 26 external to the vehicle V. In this example, the first enclosure 24 may be attached to the ROV or AUV using any suitable type of attachment.

As discussed above, the connector hub 20 may be a multi-port hub, such as a USB hub or the like, allowing for connection to multiple systems and devices. As a non-limiting example, in addition to the connection of wireless communication module 18 to the connector hub 20, at least one global navigation satellite system (GNSS) module and/or at least one global positioning satellite (GPS) module may be connected to connector hub 20. Such navigation and location modules may be received within the first enclosure 22 or the second enclosure 28, and secured therein using any suitable type of fasteners, brackets or the like. As a further non-limiting example, the remote station 26 may include, or be in communication with, a user interface, allowing a user to receive feedback from the remote station 26 and/or program or control the operations of the remote station 26.

It is to be understood that the fiber optic communication system for vehicles is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A fiber optic communication system for vehicles, comprising:
a first fiber optic converter adapted to be carried by a vehicle and adapted for electrical connection to at least one user device;
a second fiber optic converter adapted to be positioned remotely from the vehicle and the first fiber optic converter;
at least one fiber optic cable optically coupling the first fiber optic converter and the second fiber optic converter; and
a wireless communication module in electrical communication with the second fiber optic converter,
wherein the first fiber optic converter is configured to convert first electrical signals received from the at least one user device into first optical signals, and is further configured to convert second optical signals into second electrical signals received by the at least one user device, and,
wherein the second fiber optic converter is configured to convert the first optical signals from the first fiber optic converter into third electrical signals received by the wireless communication module, and is further configured to convert fourth electrical signals received from the wireless communication module into the second optical signals received by the first fiber optic converter.

2. The fiber optic communication system for vehicles as recited in claim 1, further comprising a connector hub, wherein the wireless communication module is electrically connected to the second fiber optic converter through the connector hub.

3. The fiber optic communication system for vehicles as recited in claim 2, further comprising a first enclosure, wherein the second fiber optic converter and the connector hub are each received within the first enclosure.

4. The fiber optic communication system for vehicles as recited in claim 3, wherein the first enclosure is waterproof.

5. The fiber optic communication system for vehicles as recited in claim 4, wherein the wireless communication module is located external to the first enclosure.

6. The fiber optic communication system for vehicles as recited in claim 5, further comprising a second enclosure, wherein the wireless communication module is received within the second enclosure.

7. The fiber optic communication system for vehicles as recited in claim 6, wherein the second enclosure is waterproof.

8. The fiber optic communication system for vehicles as recited in claim 1, wherein the wireless communication module comprises:
a wireless transceiver; and
a wireless antenna in electrical communication with the wireless transceiver.

9. The fiber optic communication system for vehicles as recited in claim 8, wherein the wireless communication module further comprises a radio frequency amplifier in electrical communication with the wireless transceiver and the wireless antenna.

10. The fiber optic communication system for vehicles as recited in claim 2, further comprising at least one global navigation satellite system module in electrical communication with the connector hub.

11. The fiber optic communication system for vehicles as recited in claim 2, further comprising at least one global positioning satellite module in electrical communication with the connector hub.

12. The fiber optic communication system for vehicles as recited in claim 6, further comprising a telescopic mast wherein the telescopic mast is configured to support the wireless antenna in a raised position.

13. The fiber optic communication system for vehicles as recited in claim 6, further comprising a telescopic mast wherein the telescopic mast is configured to support the wireless antenna in a desired orientation.
